(19) United States
(12) Patent Application Publication
(10) Pub. No.: US 2018/0243786 A1
(43) Pub. Date: Aug. 30, 2018

(54) Vacuum Shut Off Valve Mechanism For A Soil Fumigant Applicator Rig

(71) Applicant: Triest Ag Group, Incl., Greenville, NC (US)

(72) Inventor: Jonathan Cory Spence, Thomasville, GA (US)

(73) Assignee: Triest Ag Group, Inc., Greenville, NC (US)

(21) Appl. No.: 15/883,719

(22) Filed: Jan. 30, 2018

Related U.S. Application Data
(60) Provisional application No. 62/451,895, filed on Jan. 30, 2017.

(51) Int. Cl. B05C 11/10

(52) U.S. Cl. CPC B05C 11/1039; A01M 17/002

(57) ABSTRACT

A vacuum shut off valve mechanism for a soil fumigant applicator includes a pneumatic cylinder that is operably connected to respective fumigant dispensing tubes and shanks of the applicator through a flow divider. A pair of switch operated valves respectively control the flow of fumigant to the flow divider and operation of the pneumatic cylinder. In a first switch state a first valve is opened to deliver fumigant to the flow divider and a second valve operates the pneumatic cylinder to pressurize the flow divider and allow delivery of the fumigant to the dispensing shanks. In a second state, the first valve is closed and the second valve operates the pneumatic cylinder to draw a vacuum, which restricts dripping and leaking of residual fumigant from the tubes and dispensing shanks.

### RELATED APPLICATION

This application claims the benefit of U.S. Provisional Application Ser. No. 62/451,895 filed Jan. 30, 2017.

### FIELD OF THE INVENTION

This invention relates to a shut off valve mechanism for use on a soil fumigant applicator rig. More particularly, the valve mechanism effectively controls dripping, and leaking of fumigant from the dispensing tubes and shanks of the applicator that otherwise occurs when the rig reaches the end of a row in a field being treated, or otherwise halts operation.

### BACKGROUND OF THE INVENTION

Agricultural fields are commonly treated with fumigants to control harmful pests such as nematodes, fungi, bacteria, insects and weeds that can be harmful to the crops being cultivated in the field. Typically, the soil fumigant is applied prior to planting by a fumigation applicator rig that is driven back and forth along successive rows of the field. The rig carries a supply of a selected fumigant, which is injected or otherwise dispensed into the soil through knife-like shanks. The shanks are connected to the fumigant supply through a series of delivery tubes. Each tube extends down the back of a respective shank to its tip.

During operation of the fumigation rig, the delivery of fumigant to the field is conventionally controlled by various types of switches and valves. A significant problem often occurs when the dispensing operation is interrupted, such as when the applicator rig reaches the end of a row being treated or halts operation. After the operator shuts off the flow of fumigant and lifts the dispensing shanks, excess product remaining in the section of tubing mounted to the shank tends to drip or leak from the tip of the shank and onto the ground. This creates a number of difficulties. The dripping noxious chemical can burn worker eyes and interfere with their breathing. In addition, a number of soil fumigants are corrosive to metals and can damage the dispensing shanks of the rig. Such shanks are commonly composed of brass, which is apt to be seriously corroded by leaking fumigant. The metal dispensing tubes, which are welded to the shanks, are also subject to fumigant corrosion. It can be quite expensive, time consuming and inefficient to replace pieces and parts of the applicator rig that are corroded and damaged in this manner.

Various approaches have been taken to resolve the foregoing problem. Check valves have been employed to stop the flow of fumigant at times when the product does not have to be dispensed. However, such valves cannot be positioned at or near the tip of the shank because they will be torn away or damaged as the shank cuts through the ground during operation of the rig. Accordingly, conventional check valves are typically mounted above the shank. As a result, they are unable to prevent excess fumigant from dripping out of the dispensing tubes when the rig reaches the end of a row or when operation of the rig is otherwise halted. Conventional check valves are also subject to unintended opening as the applicator drives across and often bounces over rough or uneven terrain. Such check valves are particularly susceptible to opening as the machine bounces during turns made at the end of each row. This can contribute to even more dripping and leaking of excess fumigant.

The leakage and dripping of excess fumigant from the shank, as well as the loss of fumigant caused by unintended opening of the check valves during operation of the rig has been a challenge in the fumigation industry for many years. The loss of fumigant in this manner can have serious cost ramifications. It is estimated that approximately 16 oz of product may be lost per pass on an average sized agricultural field. This can result in 30-40 gallons of fumigant wasted during a typical fumigation treatment.

The excess fumigant that remains in the shank can also be flushed by introducing nitrogen into the shank through a secondary valve. This flushes the remaining fumigant from the shank and into the field so that the risk of potential corrosion is reduced. However, this technique not only wastes product, it can also oversaturate the target area with fumigant in an amount greater than that prescribed for a particular fumigation treatment.

### SUMMARY OF THE INVENTION

It is therefore an object of the present invention to provide an improved vacuum shut off valve for effectively controlling the undesirable dripping and leakage of soil fumigant from the shank of a fumigation applicator rig at times when application of product is interrupted and/or not desired such as at the end of a planting row, while the machine is turning and at times when operation of the applicator is halted.

It is a further object of this invention to provide a shut off valve for a soil fumigant applicator that effectively controls the unintended and undesirable release of noxious fumigants, which can interfere with worker's eyesight and breathing.

It is a further object of this invention to provide a shut off valve for a soil fumigant applicator, which reduces the risk of exposure to workers performing fumigation as well as other persons in the vicinity.

It is a further object of this invention to provide a shut off valve mechanism that reduces waste of fumigant product and corrosion and damage to fumigant applicator equipment.

It is a further object of this invention to provide a shut off valve mechanism that reduces the need for premature and costly repairs to the dispensing components of a fumigation rig normally caused by the dripping and leaking of excess fumigant.

It is a further object of this invention to provide a shut off valve mechanism that significantly reduces the amount of fumigant lost during the typical treatment of an agricultural field and which therefore improves the efficacy of the fumigant and lessens the product waste and equipment repair costs resulting from the dripping and leaking of residual fumigant from the shanks of a fumigation rig.

This invention results from a realization that fumigant leakage from a soil fumigation rig, as well as the negative consequences resulting therefrom are greatly reduced by employing a vacuum shut off valve that immediately and reliably stops dripping and leakage of residual fumigant from the shanks of the rig while the rig is turning between successive passes across an agricultural field and at other times when application of the fumigant is interrupted or halted.

This invention features a vacuum shut off valve mechanism for a soil fumigant applicator rig. The mechanism includes a fumigant transmitting conduit having an inlet communicably connected to a source of fumigant. A first valve component is alternately opened to conduct fumigant through the conduit and closed to block the flow of fumigant through the conduit. An outlet of the conduit is communicably connected to a flow divider that directs fumigant to a plurality of fumigant transmission tubes, each of which is operably connected to a fumigant dispensing shank.

A pneumatic cylinder device includes an elongate cylinder housing, which accommodates a piston that is slidable in a reciprocating manner through the cylinder housing. The piston separates the cylinder housing into first and second cylinder chambers. The first cylinder chamber is communicably connected with the flow divider. A piston rod attached to the piston extends longitudinally through the second chamber of the cylinder housing and is transmitted through a sealed opening in the cylinder housing. A distal portion of the piston rod outside of the cylinder housing supports a spring retainer element. A piston retractor spring extends between the cylinder housing and the spring retainer element. The piston retractor spring urges the piston into a retracted condition within the cylinder housing.

A second valve component includes a first port that is communicably connected to the second chamber of the cylinder housing. The second valve component also includes a second port that is communicably connected to a pressurized gas source and a third port that forms an exhaust vent. The second valve is alternatable between first and second states. In the first state, the first port is communicably connected to the second port and disconnected or blocked from the third port. In the second state, the first port is communicably connected to the third port and disconnected from the second port.

An ON/OFF actuator switch is operably connected to the first and second valves. In an ON condition, the ON/OFF switch directs the second valve to communicably interconnect the first and second ports and disconnect those ports from the third port. This connects the pressurized gas source to the second chamber of the pneumatic cylinder housing. As a result, the increased gas pressure delivered to the cylinder housing drives the piston through the cylinder housing to compress the retractor spring and increase the pressure within the first chamber of the housing. This, in turn, increases the pressure within the flow divider communicably connected to the cylinder housing. At the same time, the ON/OFF switch opens the first valve and fumigant is delivered to the flow divider, which retransmits the fumigant through the fumigant transmission tubes. This transmitted fumigant is then delivered to the attached shanks and dispensed into the soil.

When the ON/OFF switch is alternated to an OFF state, the second valve communicably interconnects its first and third ports and disconnects those ports from its second port. As a result, the second chamber of the pneumatic cylinder is communicably connected to the first and third ports of the second valve. The previously applied gas pressure is vented from the second chamber of the cylinder housing through the third port and the previously compressed retractor spring expands to drive the piston through the cylinder housing. As a result, the piston draws a vacuum within the first chamber of the cylinder housing. This vacuum is applied through the flow divider to the fumigant within the fumigant conducting tubes. In the OFF state, the ON/OFF switch also simultaneously closes the first valve so that the delivery of fumigant to the flow divider is discontinued. The applied vacuum sucks excess fumigant toward and into the second chamber of the cylinder housing and holds the fumigant securely within fumigant conducting tubes. This effectively prevents that fumigant from leaking or dripping from the conducting tubes or attached dispensing shanks while the switch remains in an OFF condition.

In a preferred embodiment, the pneumatic cylinder may employ a 40 lb. spring force. Nitrogen may provide the gas pressure to the cylinder housing and that pressure may be approximately 150 lbs. The first valve component may include a two-way valve and the second valve component may include a three-way valve.

### BRIEF DESCRIPTION OF THE DRAWINGS

Other objects, features and advantages will occur from the following description of a preferred embodiment and the accompanying drawing, in which:

FIG. 1 is a schematic view of the vacuum shut off valve mechanism in accordance with this invention with the ON/OFF switch in an OFF condition to prevent dripping or leaking of fumigant from the dispensing shanks; and.

FIG. 2 is an elevational schematic view of the vacuum shut off valve mechanism with the ON/OFF switch in the “ON” condition for delivering fumigant to the dispensing shanks and injecting such fumigant into the soil.

### DETAILED DESCRIPTION OF PREFERRED EMBODIMENT

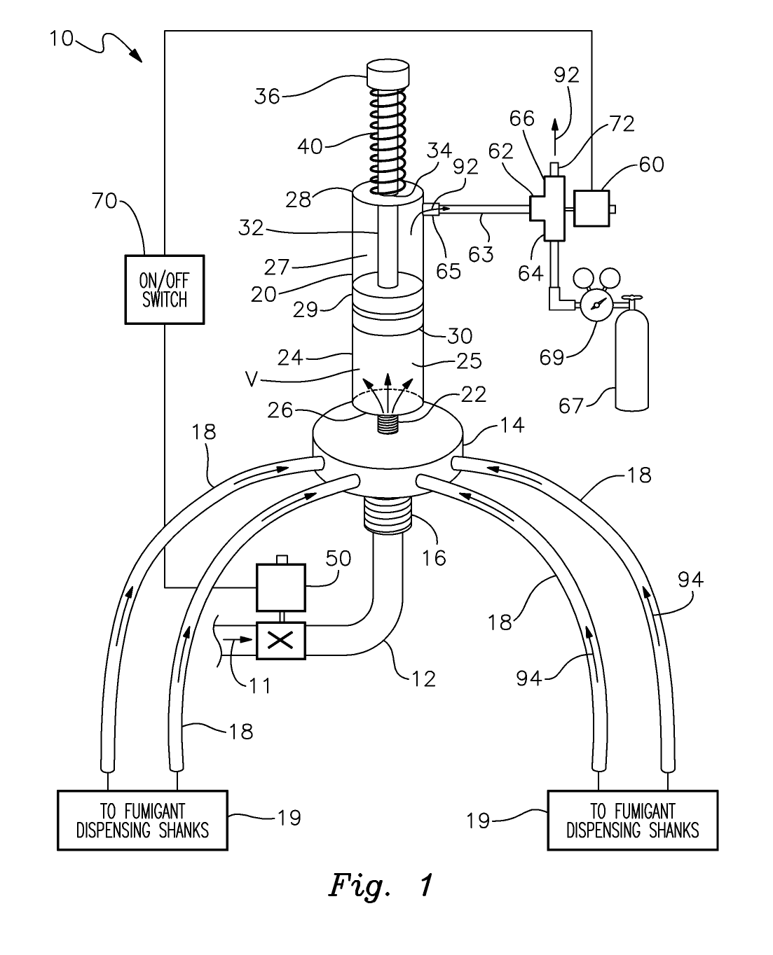

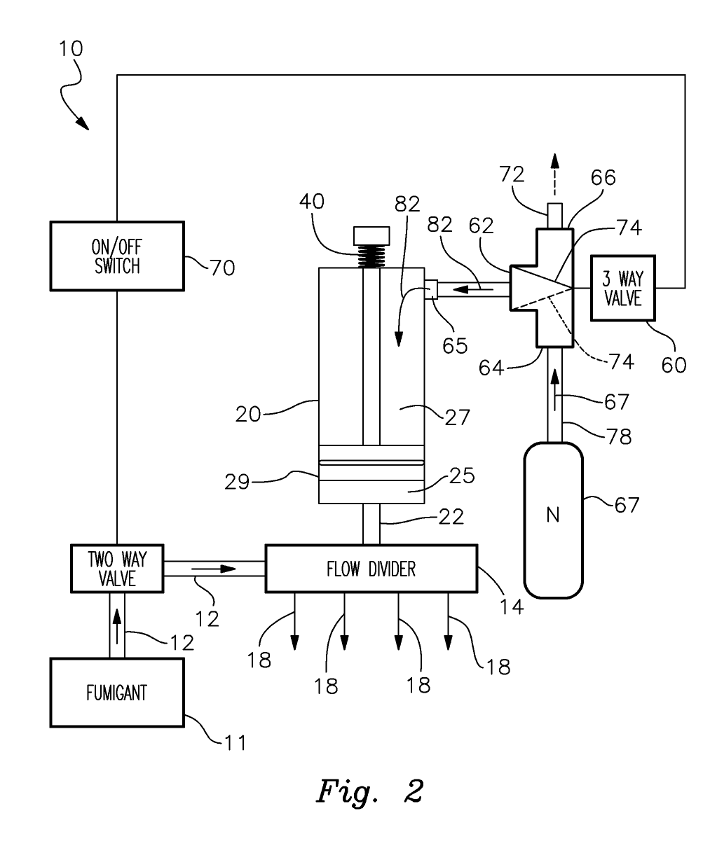

There is shown in FIGS. 1 and 2 a vacuum shut off valve mechanism 10 for use on a soil fumigant applicator rig. Although mechanism 10 is especially suited for functioning effectively and achieving improved results in conjunction with a soil fumigation rig, the mechanism may also be used for alternative liquid shut off valve applications within the scope of this invention. In addition, mechanism 10 can be used effectively with virtually all types of soil fumigants with the exception of methyl bromide. The mechanism also may be employed with fumigation rigs and fumigant applicators of all types and in virtually any planting or crop application.

The fumigation applicator rig, which is a standard machine and not shown, carries a supply of fumigant 11 that is delivered through a fumigant supply conduit 12 to a flow divider 14. In particular, an outlet end of supply conduit 12 is connected via an inlet fitting 16 to flow divider 14. The flow divider is a conventional item that may include various types of known construction for directing fumigant 11 to individual fumigant transmitting tubes 18. The fumigant transmitting tubes 18 are, in turn, connected to fumigant dispensing shanks 19 mounted to the rig in a conventional manner. It should be understood that the construction of the shanks and the tubes, as well as the means for interconnecting these components and mounting them to the rig are standard and will be understood to persons skilled in the art. In addition, it should be understood that although four tubes 18 and respective shanks 19 are depicted herein, any alternative number of tubes and shanks may be utilized within the scope of this invention. Flow dividers may be constructed according to known principles to distribute and direct the flow of fumigant to the number of tubes and respective shanks that are utilized by the rig.

Mechanism 10 critically employs a vacuum producing pneumatic cylinder device 20 that is operably connected to flow divider 14 by a cylindrical fitting 22. Pneumatic cylinder device 20 includes an elongate stainless steel cylinder housing 24 having a lower first end 26 and an opposite upper end 28. In certain preferred embodiments of this invention, the pneumatic cylinder may have a bore of 1.5″ and a stroke of 3″, although these specifications may be modified within the scope of the invention. A piston 29 operably mounted within the cylinder housing includes a piston head 30 and an attached piston rod 32, which extends upwardly from piston head 30 and through a sealed opening 34 in upper end 28 of cylinder housing 24. As described below, piston head 30 travels longitudinally through cylinder housing 24 and divides the cylinder housing into a first lower chamber 25 and a second upper chamber 27.

A Viton head seal or alternative seal appropriate for use in pneumatic cylinders is carried by piston head 30 to sealably interengage the interior walls of cylinder housing 24. A nut 36 defining a spring retention element is threadably or otherwise secured proximate an upper end of piston rod 32. A helical compression spring 40 is wound about the exterior upper portion of piston rod 32. Spring 40 extends between the top surface of upper end 28 of cylinder housing 24 and element 36. Spring 40 forms a piston retractor spring for driving the piston into a retracted condition during operation of the valve mechanism. This operation is described more fully below.

Mechanism 10 utilizes first and second valve components 50 and 60, which are in turn controlled by an ON/OFF switch 70. Valves 50 and 60 thereby control both delivery of fumigant to flow divider 14 and operation of pneumatic cylinder 20. In accordance with this invention, pneumatic cylinder 20 generates a vacuum that controls dripping and leaking of fumigant from the individual fumigant transmitting tubes 18 and attached shanks 19.

First valve component 50 comprises a two-way KZ valve for selectively opening and closing fumigant supply line 12. As previously indicated, valve 50 is electrically operated by ON/OFF switch 70. Various alternative types of solenoid valves may be employed. Opening valve 50 causes fumigant to be delivered to flow divider 14 as further described below.

Second valve 60 comprises, for example a three-way KZ valve. Again, valve component 60 is alternated between different states by operation of ON/OFF switch 70. Various other solenoid valves may be employed within the scope of this invention. Valve 60 includes first, second and third ports 62, 64 and 66, respectively. First port 62 is communicably connected through a pipe 63 to an inlet/outlet fitting 65 of cylinder housing 24. The inlet/outlet fitting 65 is in turn communicably connected with the upper second chamber 27 of cylinder housing 24. Second port 64 of valve component 60 is communicably connected to a pressurized nitrogen supply 67. The gas has a pressure of about 150 lbs. although other pressures sufficient for operating the pneumatic cylinder in a manner as described below may be employed within the scope of this invention. In addition, although nitrogen is disclosed as the preferred pressurizing gas, alternative gases may be utilized. Port 64 may be joined to pressure source 67 by appropriate piping and fittings. A pressure gauge 69 may be employed to indicate the gas pressure of supply 67.

Third port 66 defines a vent 72. Various pipes and fittings may be inserted in to port 66 to form the vent. Alternatively, the port itself may define the vent. Second valve 60 operates schematically as best depicted in FIG. 2. Specifically, in a first or “ON” state, an internal valve closure element 74 is positioned so that ports 62 and 64 are communicably connected, whereas port 66 is disconnected from ports 62 and 64. Alternately, in the “OFF” position shown in phantom, closure element 74 is positioned so that ports 62 and 66 are communicably interconnected and port 64 is disconnected from port 62 and 66.

Mechanism 10 may be mounted in any acceptable manner within the fumigation rig or other apparatus for which mechanism 10 is used. The particular details for mounting the system or arranging components of the system on the applicator rig may be varied within the scope of this invention and should be understood by persons skilled in the art. ON/OFF switch 70 should be positioned on the rig so that it is conveniently accessible to the operator. Various known types of electrical or alternative switches may be employed. Switch 70 is alternated between ON and OFF conditions or open and closed states to alternately dispense fumigant from the rig or operate the shut off valve mechanism so that dripping and leaking of retained fumigant from the transmission tubes 18 and fumigant dispensing shanks 19 is controlled.

In operation, switch 70 is turned ON to dispense fumigant and treat the field. In particular, in the ON condition, switch 70 directs valve component 50 to open fumigant supply line 12. As a result, as best shown in FIG. 2, fumigant 11 is delivered through supply line 12 and open two-way valve 50 to flow divider 14. At the same time, switch 70 directs three-way valve 60 to operate valve closure 74 in the manner shown in FIG. 2 such that pressurized nitrogen gas 67 is delivered through piping 78 to port 64 of valve 60. Ports 64 and 62 are communicably interconnected, as shown, so that the pressurized nitrogen gas proceeds as indicated by arrows 82. In particular, the nitrogen gas enters upper second chamber 27 of pneumatic cylinder housing 20 through inlet/outlet 65. The 150 lbs. of gas pressure overcomes the 40 lbs. resistance of spring 40. As a result, piston 29 is driven longitudinally and downwardly through cylinder housing 24 against spring 40, which compresses. Lower chamber 25 of pneumatic cylinder 20 is pressurized and this pressure increase is transmitted by fitting 22 to flow divider 14. As a result, fumigant is directed through tubes 18 in the manner shown in FIG. 2 to dispensing shanks 19. The delivered fumigant is thereby dispensed by the shanks into the soil of the agricultural field being treated.

When the fumigation rig reaches the end of a row or pass across the field and is turning or, alternatively when operation of the rig is temporarily halted or the fumigant application process has been completed, the operator turns switch 70 off. The ON/OFF switch thereby directs two-way valve 50 to close so that no further fumigant is delivered through supply conduit 12 to flow divider 14. In this state, mechanism 10 operates to shut off the discharge of any extra or residual fumigant remaining in tubes 18 and/or in the dispensing shanks. Specifically, switch 70 directs three-way valve 60 to operate so that closure 74 assumes the position shown in phantom in FIG. 2. First port 62 of valve 60 is thereby communicably joined to vent 72 formed in port 66. Port 64 is closed and the pressurized nitrogen supply 67 is effectively blocked from port 62 and 66. As a result, as best shown in FIG. 1, upper or second chamber 27 of pneumatic cylinder 20 is vented to the atmosphere. As indicated by arrows 92, nitrogen gas is allowed to escape from chamber 27 through inlet/outlet fitting 65, pipe 63, port 62 and communicably open vent 72. Release of the pressurized gas from the pneumatic cylinder is facilitated by operation of the retraction spring, which expands from the compressed position shown in FIG. 2 to the retracted condition shown in FIG. 1. Piston 29 is thereby retracted upwardly within cylinder housing 24 and a vacuum V is drawn within lower, first chamber 25. This vacuum is applied to the fumigant remaining in tubes 18 through flow divider 14. At least some of the remaining fumigant is drawn into first chamber 25. The stainless steel construction of the pneumatic cylinder 20 and flow divider 14 enables those components to resist corrosion and damage from the fumigant drawn into the cylinder. The vacuum drawn by pneumatic cylinder 20 thereby securely holds the fumigant remaining in tubes 18 and dispensing shanks 19. Arrows 94 in FIG. 1 depict the negative pressure effectively drawing the fumigant upwardly through the tubes. The vacuum pressure is sufficient to shut off further discharge and prevent any dripping or leaking of residual fumigant from the tubes or the shanks.

The individual components of this invention may be constructed of durable metals and plastic materials of the type commonly used for fumigant application equipment. The pneumatic cylinder may include a SpeedAire™ pneumatic cylinder or comparable device.

The switch may be interconnected with the first and second valves in alternative ways within the scope of this invention. For example, the switch and valves may be assembled and constructed so that in an OFF state the fumigant is dispensed and in an ON state dripping and leakage of residual fumigant from the tubes and shanks is shut off.

The vacuum shut off mechanism of this invention works reliably, completely and virtually instantaneously to prevent unintended and problematic dripping and leaking of fumigant from the tubes and shanks of a fumigation rig or applicator. Dripping is controlled by simply activating the ON/OFF switch as each pass across the field is concluded, during turns and other times when operation of the applicator is halted and further dispensing of fumigant is not desired. As a result, a number of benefits are provided. Irritating and potentially harmful, noxious chemicals are not dripped onto the field. Workers experience far less irritation to their eyes, nose and throat and fewer respiratory problems. Elimination of fumigant dripping also reduces premature corrosion of brass shanks, metal tubes and other components of the fumigation rig. Operational delays and costly repairs are also minimized. Far less product is wasted, which also saves considerable expense.

While this detailed description has set forth particularly preferred embodiments of the apparatus of this invention, numerous modifications and variations of the structure of this invention, all within the scope of the invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

What is claimed is:

1. A shut off valve mechanism for a soil fumigant applicator rig, said mechanism comprising:
a pneumatic cylinder device including an elongate cylinder housing, which housing accommodates a piston slidable in a reciprocating manner through said cylinder housing, said piston separating said cylinder housing into first and second cylinder chambers;
a spring biasing said piston into a retracted condition within said cylinder housing;
a flow divider communicably interconnecting said first cylinder chamber and at least one fumigant dispensing shank;
a first valve communicably interconnecting a source of fumigant and said flow divider, said first valve being selectively opened to introduce fumigant from said source to said flow divider and closed to block the flow of fumigant from said source to said flow divider;
a second valve communicably connected to said second chamber of said cylinder housing; and
an actuator switch operably connected to said first and second valves, said actuator switch being selectively alternated between a first condition, wherein said first valve is opened and said second valve connects a source of pressurized gas with said second chamber of said pneumatic cylinder to drive said piston through said cylinder housing and increase pressure within said second chamber of said cylinder housing and said flow divider such that fumigant is dispensed through each fumigant dispensing shank, and a second condition wherein said first valve is closed and said second valve vents said pressurized gas from said second chamber of said cylinder housing such that said spring drives said piston into said retracted condition, which draws a vacuum within said first chamber and said flow divider to shut off dispensing of fumigant by each dispensing shank of the rig.
